(19) United States
(12) Patent Application Publication
(10) Pub. No.: US 2003/0234142 A1
(43) Pub. Date: Dec. 25, 2003

(54) Supplemental inserts to improve wheel conditioning

(75) Inventors: Bruce W. Shute, West End, NC (US); Thomas W. McCabe, Southern Pines, NC (US); Gary Bowden, Laurinburg, NC (US); Timothy Rumph, Laurel Hill, NC (US)

Correspondence Address: JAMES RAY ASSOCIATES, 2640 PITCAIRN ROAD, MONROEVILLE, PA, 15146, US

(73) Assignee: WESTINGHOUSE AIR BRAKE TECHNOLOGIES CORPORATION

(21) Appl. No.: 10/178,379

(22) Filed: Jun. 24, 2002

(51) Int. Cl. F16D 65/04

(52) U.S. Cl. 188/250 B

(57) ABSTRACT

A brake shoe for use on a railway vehicle for reconditioning a wheel tread surface during a normal braking application including a backing plate and a first friction material extending over the brake surface of such brake shoe. It further contains a second friction material, formed as a discrete insert molded into such first friction material. Such second friction material initially is completely embedded. One surface of the insert is incrementally exposed as the first friction type material is eroded away. Such second friction material exhibits abrasive properties and is bonded to such backing plate. A third friction material is disposed as another discrete insert imbedded in the first friction type material. One surface of the abrasive third friction material being disposed as part of the brake surface of the brake shoe.

### CROSS REFERENCE TO RELATED APPLICATIONS

The invention taught in this patent application is closely related to the invention taught in the following co-pending patent application, SUSPENDED INSERT TO PROVIDE WHEEL CONDITIONING, Ser. No. ______ which is being filed concurrently herewith. These patent applications are assigned to the same assignee and the teachings therein are incorporated into this application by reference thereto.

### FIELD OF THE INVENTION

The present invention relates, in general, to railway vehicle type braking equipment and, more particularly, this invention relates to a composition type brake shoe for use in a railway type vehicle brake system and, even still more specifically, the invention relates to an improved brake shoe member with inserts of aggressive high friction material for reconditioning the tread surface of a wheel during normal braking operation.

### BACKGROUND OF THE INVENTION

Prior to the conception and subsequent development of this invention, it is generally well known in the art to use various type brake shoes having different compositions to achieve quite specific braking requirements. For example, these compositions may include cast iron and various other type friction materials that are specifically formulated for a number of predetermined applications.

It is further well recognized, in the brake shoe art, that these various types of friction material will normally exhibit a number of uniquely different friction characteristics. Such friction characteristics, for example, include both high friction material and low friction material which are usually selected on the basis of braking performance requirements.

Since braking performance is the prime function of brake shoes, use of such lower type friction material may be adequate for braking purposes. However, there is normally no consideration of providing a secondary beneficial function toward the reconditioning of a wheel tread surface that may have surface defects, such as shells or spalls. Removal of these surface defects will normally extend the useful life of a wheel that is in service.

A brake shoe surface could be used which would be aggressive as far as reconditioning the wheel surface; however, this design may not provide appropriate friction levels for braking and may also have a disadvantage of creating significant sparking during brake applications which could result in a hazardous condition.

Applicant is aware of another design which is a shoe material made entirely from the aggressive grinding type material, however, this shoe must be applied and then immediately removed after a very low speed brake application. Thus, there is a need for a reconditioning brake shoe that will not present a safety problem because of inappropriate friction performance or because of a sparking condition while the brake shoe is reconditioning the defective surface of a wheel tread and still further a brake shoe that can continue to be used for normal braking operations after the wheel tread has been reconditioned.

Another method for reconditioning a wheel tread during normal braking operation is taught in U.S. Pat. No. 6,250,040. The teaching of which is incorporated herein by reference thereto.

### SUMMARY OF THE INVENTION

The present invention provides a brake shoe for use on a railway vehicle for reconditioning a wheel tread surface during a normal braking application on such railway vehicle. The brake shoe includes a backing plate having a stirrup and a brake surface having a predetermined configuration and a predetermined surface area. It further includes a first friction type material extending over the surface area of such brake surface of such brake shoe. The brake shoe further contains a second friction type material, formed as at least one discrete insert, having a predetermined shape and molded into such first friction type material. Such second friction type material initially being completely embedded within such first friction type material, one surface of at least one discrete insert being disposed so as to coincidently be part of said brake surface of said brake shoe when one surface of the at least one discrete insert is exposed as first friction type material is eroded away due to frictional engagement with such wheel tread surface during normal braking operations. The second friction type material exhibits greater abrasive properties than the first friction type material. The at least one discrete insert of said second friction material is affixed to said backing plate.

There is a third friction material disposed as at least one discrete insert that is imbedded in the first friction type material. The third friction material has a predetermined shape and is molded into the first friction type material. One surface of the at least one discrete insert of the third friction material being disposed as part of the brake surface of the brake shoe. The third friction type material exhibits greater abrasive properties than the first friction type material.

### OBJECTS OF THE INVENTION

It is, therefore, one of the primary objects of the present invention to provide a brake shoe with an aggressive grinding material in a composition brake shoe matrix which will remove defects from the tread surface of a wheel during normal braking applications.

It is also an object of the present invention to provide a brake shoe which will at least substantially minimize production of a sparking condition while removing defects from the tread surface.

Another object of the present invention is to provide a brake shoe which will begin to recondition a wheel tread from the time the brake shoe is installed.

It is still another object of the present invention to provide a brake shoe which will extend the useful life of a wheel in service by reducing the need to remachine or reprofile wheels to remove defects from the tread surface.

Yet, it is still another object of the present invention to provide a brake shoe which will provide the correct friction for braking while at the same time removing wheel tread surface defects.

Still, it is another object of the present invention to provide a brake shoe which will strengthen such backing plate at stress points where potential failures may occur.

Additionally, it is a further object of the present invention to provide a brake shoe which can be used to recondition a wheel tread and still remain in service on the railway vehicle until the shoe is fully worn.

In addition to the various objects and advantages of the present invention which have been described in some specific detail above, various additional objects and advantages of the invention will become much more readily apparent to those persons who are particularly skilled in the relevant brake shoe friction art from the following more detailed description of such invention, particularly, when such detailed description is taken in conjunction with the attached drawing Figures and with the appended claims.

### BRIEF DESCRIPTION OF THE DRAWINGS

FIG. 1 is a plan view of the back of a railway brake shoe showing a steel backing plate used for mounting a brake shoe to the railway vehicle in a first embodiment of the invention.

FIG. 2 is a side elevation view of the railway brake shoe illustrated in FIG. 1.

FIG. 3 is a cross sectional view of the railway brake shoe taken along the lines III-III of FIG. 1 which incorporates a presently preferred embodiment of the present invention therein.

FIG. 4 is a cross sectional view of the railway brake shoe taken along the lines IV-IV of FIG. 2.

### BRIEF DESCRIPTION OF THE PRESENTLY PREFERRED AND VARIOUS ALTERNATIVE EMBODIMENTS OF THE INVENTION

Prior to proceeding to the more detailed description of the present invention, it should be noted that for the sake of clarity in understanding the invention, identical components with identical functions have been designated with identical reference numerals throughout the drawing Figures.

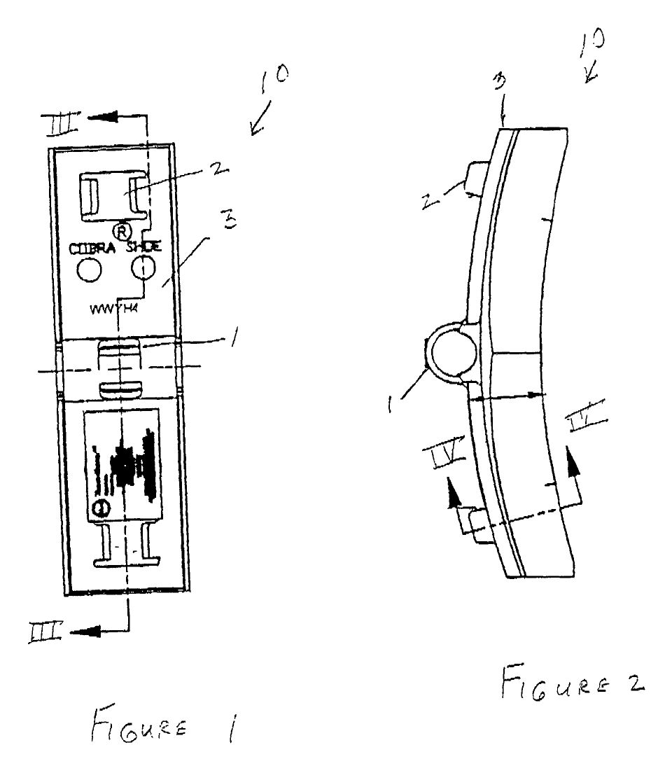

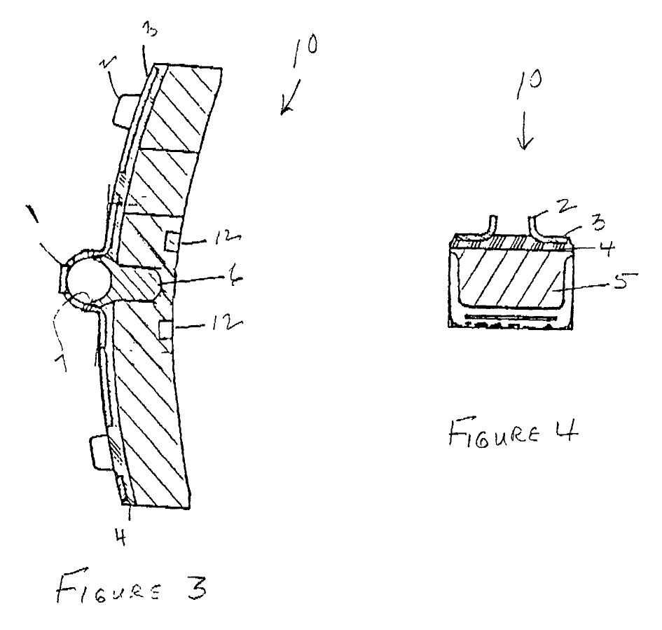

Reference is now made more specifically to FIGS. 1-4, illustrated therein is a conventional brake shoe configuration, generally designated 10, capable of having an embodiment of the present invention incorporated therein. Brake shoe 10 includes a stirrup 1 connected to a backing plate 3 to which a brake shoe member is secured. Brake shoe 10 further includes an abutment portion 2 which engages a brake head cavity (not shown). The backing plate 3 and abutment portion 2 are used to position and attach such brake shoe 10 to the brake head portion (not shown) of the brake beam portion of a predetermined brake system.

Reference is now made more specifically to FIG. 3. Illustrated therein is a presently preferred embodiment of the invention. As shown therein, brake shoe 10 has a steel backing plate 3 and a backing stock layer 4 for bonding first friction type material 5 of the brake shoe 10 to the backing plate 3. First friction material 5, according to the present invention, extends over the surface area of brake shoe 10 and provides the required friction and braking effort when forced against the tread of a railway wheel. The surface of such brake shoe 10, when used in a railway braking system, will exhibit a generally arcuate shape. First friction material 5 will hereinafter be referred to as base material 5.

Embedded in such base material 5 is at least one discrete insert 6 of a second friction type material. Such discrete insert 6 has a predetermined shape and a predetermined width and is molded into base material 5. Discrete insert 6 of second friction type material initially is completely embedded within base material 5. One surface of the at least one discrete insert 6 of second friction material is disposed so as to coincidently be part of the brake surface of the brake shoe 10 when the one surface of the at least one discrete insert 6 is exposed after a portion of the first friction type material 5 is eroded away due to frictional engagement with the wheel tread surface during normal braking operations. The one surface of the one discrete insert 6 being disposed so as to contact a wheel tread of a brake wheel (not shown). Discrete insert 6 of second friction type material exhibits greater abrasive properties than does such base material 5 and enhances friction performance of brake shoe 10 under adverse weather conditions. Such second friction type material consists essentially of a material used for grinding wheels. An inner surface 7 of discrete insert 6 of second friction material is adjacent such backing plate 3. Also in a presently preferred embodiment of the invention such inner surface 7 of discrete insert 6 of second friction material is affixed to the inner portion of the stirrup 1 of backing plate 3. By bonding such discrete insert 6 of such second friction material to the stirrup 1, additional strength is provided to the stirrup 1. Further, bonding such discrete insert 6 to such backing plate 3 holds the second friction material in place while the first friction material 5 is bonded around such discrete insert 6. It is important that the discrete insert 6 be imbedded within and not extend to the surface of such first friction composition material 5 so as to permit such first friction composition material 5 to flow properly around such discrete insert 6 during manufacture. In a presently preferred embodiment of the invention such bonding or affixing of discrete insert 6 to backing plate 3 is by means of welding. In a preferred embodiment of the invention such second friction material is cast iron or sintered iron.

It has been determined that the railroad industry prefers that the brake shoe begin reconditioning the wheel tread of the railway wheel as soon as the conditioning brake shoe is mounted on the railway vehicle.

Thus, the present invention further provides a third friction material that is also disposed as at least one discrete insert 12. Such discrete insert 12 is imbedded in said first friction type material 5. Discrete insert 12 of the third friction material has a predetermined shape and is molded into first friction type material 5. One surface of the at least one discrete insert 12 of the third friction material being disposed as part of the brake surface of brake shoe 10 and thus faces the wheel tread of a railway wheel (not shown). The third friction type material exhibits greater abrasive properties than does first friction type composition material and is used to condition the wheel tread from the moment the brake shoe is put on the railway vehicle. The third friction type material is selected from one of cast iron, sintered iron and a ceramic grinding material such as that used for grinding wheels.

With the insert 12 of the third friction material conditioning of the wheel tread begins immediately after such brake shoe is installed and continues until such time as the insert(s) 12 is eroded away due to frictional engagement with the wheel tread during normal braking operations. When such inserts 12 of such third frictional material are eroded away then the discrete insert 6 of such second frictional material is ready to begin conditioning the wheel tread and will continue to condition the wheel tread up to the condemning point of the brake shoe 10.

The discrete insert 12 of the third frictional material has a predetermined shape and a predetermined width. The shape is a generally rectangular shape. However, it is preferred that the shape be slightly trapezoidal to insure that the insert 12 is retained in the first friction material 5. The width of the insert 12 along a longitudinal axis of the brake shoe 10 in a first embodiment is the minimum width necessary in order to effectively condition the wheel tread. In an embodiment of the invention such width is between about 0.8 and 1.2 inches. In a more preferred embodiment such width is between about 0.9 and about 1.1 inches while in the most preferred embodiment such width is between about 0.95 and about 1.02 inches.

Such discrete insert 12 of the third frictional material may be a single insert or it could be two or more inserts 12 disposed in the base material 5. In a presently preferred embodiment of the invention there are two inserts 12, one disposed on each half of the brake shoe. Where more than one insert 12 is used then the minimum width that is required to effectively condition the wheel tread is split between the inserts 12. Thus, if two inserts 12 are used, then each of the inserts 12 might be 0.5 inches in width so as to provide the effective total width for conditioning the wheel tread. The width of discrete insert 6 of second friction material is substantially the same width as the combined width of the discrete inserts 12. Further discrete insert(s) 12 extend into the brake shoe for a distance that is equivalent to the distance that the outer surface of discrete insert 6 is disposed from the braking surface of first friction material 5, so that when discrete insert(s) 12 is worn away from frictional engagement with the wheel tread of railway wheel then conditioning of the tread is continued by discrete insert 6.

This complete process is designed to extend the useful life of a wheel in service in which the wheel tread of a railway wheel is conditioned from the moment that the brake shoe is mounted on the rail car. The process requires a minimum of wheel tread maintenance effort on a wheel, which has exhibited certain types of tread defects, since all that is required to recondition such wheel tread is the replacement of an existing brake shoe with a brake shoe 10 of the instant invention. The wheel tread surface is reconditioned during normal braking operations without any additional labor. Thus, brake shoe 10 reconditions the wheel tread surface and can remain on the railway vehicle for the life of the brake shoe. With the reconditioning of the wheel tread, the useful life of the wheel is extended significantly.

While both the presently preferred and a number of alternative embodiments of the present invention have been described in detail above it is understood that various other adaptations and modifications of the present invention can be envisioned by those persons who are skilled the relevant art of brake shoes without departing from either the spirit of the invention or the scope of the appended claims.

We claim:

1. A brake shoe for use on a railway vehicle for both applying a braking force and simultaneously reconditioning a wheel tread surface of a wheel disposed on such railway vehicle during a normal braking application on such vehicle, said brake shoe comprising:
(a) a backing plate having a predetermined configuration;
(b) a first friction type material formed into a brake shoe having a predetermined shape;
(c) a brake surface for engaging a wheel tread having a predetermined configuration formed on said brake shoe and having a predetermined surface area;
(d) a second friction type material formed as at least one discrete insert, having a predetermined shape and molded into said first friction type material, said second friction type material initially being completely embedded within said first friction type material, one surface of said at least one discrete insert being disposed so as to coincidently be part of said brake surface of said brake shoe when said one surface of said at least one discrete insert is exposed as said first friction type material is eroded away due to frictional engagement with such wheel tread surface during normal braking operations, said one surface of said at least one discrete insert having a predetermined width which is at least sufficient to recondition such wheel tread surface, said second friction type material exhibiting greater abrasive properties than said first friction type material, an inner surface of said at least one discrete insert of said second friction material is disposed adjacent said backing plate; and
(e) a third friction material formed as at least one discrete insert embedded in said first friction type material, said third friction material having a predetermined width and shape, one surface of said at least one discrete insert of said third friction material being disposed as part of said brake surface of said brake shoe, said third friction type material exhibiting greater abrasive properties than said first friction type material.

2. A brake shoe for use on a railway vehicle, according to claim 1, wherein said at least one discrete insert of said second friction material is metallic.

3. A brake shoe for use on a railway vehicle, according to claim 2, wherein said metal is one of cast iron and sintered iron.

4. A brake shoe for use on a railway vehicle, according to claim 1, wherein said backing plate further includes a stirrup portion and said at least one discrete insert of said second friction material is affixed to an inner surface of said stirrup portion of said backing plate.

5. A brake shoe for use on a railway vehicle, according to claim 4, wherein said at least one discrete insert is affixed to said backing plate by welding which further strengthens said stirrup portion of said backing plate.

6. A brake shoe for use on a railway vehicle, according to claim 1, wherein said brake shoe includes at least two discrete inserts of said third friction material.

7. A brake shoe for use on a railway vehicle, according to claim 6, wherein said at least two discrete inserts are selected from at least one of cast iron, sintered iron and ceramic grinding material used for grinding wheels.

8. A brake shoe for use on a railway vehicle, according to claim 7, wherein said discrete inserts are at least one of cast iron and sintered iron.

9. A brake shoe for use on a railway vehicle, according to claim 8, wherein said discrete inserts are cast iron.

10. A brake shoe for use on a railway vehicle, according to claim 1, wherein said predetermined width of said at least one discrete insert of said third friction material taken along a longitudinal axis of said brake shoe is between about 0.8 inches and about 1.2 inches.

11. A brake shoe for use on a railway vehicle, according to claim 10, wherein said predetermined width is between about 0.9 inches and about 1.1 inches.

12. A brake shoe for use on a railway vehicle, according to claim 11, wherein said predetermined width is between about 0.95 inches and about 1.05 inches.

13. A brake shoe for use on a railway vehicle, according to claim 6, wherein a sum of said predetermined width taken along a longitudinal axis of said brake shoe for said at least two discrete inserts of said third friction material is between about 0.8 and about 1.2 inches.

14. A brake shoe for use on a railway vehicle, according to claim 1, wherein said predetermined width of said at least one discrete insert of said second friction material taken along a longitudinal axis of said brake shoe is between about 0.8 inches and about 1.2 inches.

15. A brake shoe for use on a railway vehicle, according to claim 14, wherein said predetermined width is between about 0.9 inches and about 1.1 inches.

16. A brake shoe for use on a railway vehicle, according to claim 15, wherein said predetermined width is between about 0.95 inches and about 1.05 inches.

17. A brake shoe for use on a railway vehicle, according to claim 1, wherein said predetermined configuration of said brake surface is arcuate in a longitudinal direction.

18. A brake shoe for use on a railway vehicle, according to claim 1, wherein said first friction type material is bonded to said metal backing plate during molding.

19. A brake shoe for use on a railway vehicle, according to claim 1, wherein said predetermined shape of said first friction type material is generally rectangular on a plane disposed perpendicular to that of a longitudinal direction of said brake shoe and said predetermined surface area of said brake surface exhibits a concave shape so as to conform to a surface of a wheel tread of a railway wheel and an opposed surface to said brake surface exhibits a convex shape for molding to said backing plate of said brake shoe and generally arcuate edges disposed along said longitudinal direction of said brake shoe.

20. A brake shoe for use on a railway vehicle, according to claim 1, wherein said discrete insert of said third friction material extends into said first friction material to substantially a depth that is equivalent to a distance from an outer surface of said discrete insert of said second friction material to said brake surface of said brake shoe.

21. A brake shoe for use on a railway vehicle, according to claim 1, wherein said at least one discrete insert of said second friction material disposed adjacent said backing plate is positioned such that it will always have a minimum width exposed to such wheel tread up to a condemning point of said brake shoe.
